(19) United States
(12) Patent Application Publication
(10) Pub. No.: US 2004/0020458 A1
(43) Pub. Date: Feb. 5, 2004

(54) Method for operating a pump-nozzle unit and a corresponding pump-nozzle unit

(76) Inventor: Roger Potschin, Brackenheim (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/297,218

(22) PCT Filed: Apr. 4, 2002
(86) PCT No.: PCT/DE02/01235

(30) Foreign Application Priority Data
Apr. 4, 2001 (DE) 101 16 635.4

(51) Int. Cl. F02B 3/00

(52) U.S. Cl. 123/294

(57) ABSTRACT

A unit fuel injector (10) is used to inject fuel into the combustion chamber of an internal combustion engine. This is accomplished by opening a valve element (28) counter to a valve prestressing force by means of increasing a system pressure. Moreover, the system pressure is raised to a value above a normal valve opening pressure, so that the valve element opens for a main injection counter to the valve prestressing force. While the system pressure is being raised, the valve prestressing force is also increased, in such a way that a valve closing pressure that is increased because of the increased valve prestressing force is always below the system pressure. The system pressure is then lowered and to a value below the valve closing pressure, so that the valve element closes. Next, the system pressure is increased again, so that the valve element opens for a postinjection, at a valve opening pressure that is increased because of the increased valve prestressing force. Finally, the system pressure is lowered again, and the valve prestressing force is lowered as well, so that the valve element (28) closes.

### PRIOR ART

The invention first relates to a method for operating a unit fuel injector, with which fuel is injected into a combustion chamber of an internal combustion engine, in such a way that a valve element is opened counter to a valve prestressing force by an elevation of a system pressure, the method including the following steps in succession:

a) raising the system pressure to a value above a normal valve opening pressure, so that the valve element opens counter to the valve prestressing force for a main injection;

b) increasing the valve prestressing force during the raising of the system pressure;

c) lowering the system pressure and decreasing the valve prestressing force, so that the valve element closes.

One such method is known on the market. It is used for instance in unit fuel injectors of Diesel engines in motor vehicles. Such unit fuel injectors include a valve element, which is pressed by a spring into its closing position. A piston pump driven by a camshaft furnishes a system pressure, which engages a pressure face of the valve element, and with which the valve element can be opened counter to the valve prestressing force. The spring that presses the valve element into its closing position is braced on its other end on a movable switch element. If the switch element is moved toward the valve element, then the valve prestressing force acting on the valve element increases, along with the valve opening pressure and valve closing pressure that are directly dependent on it.

With the known method, a double injection can be achieved:

First, the system pressure is increased, so that the valve element opens counter to the spring force. Then the switch element is moved, and the valve prestressing force increases. This is done in such a way that the valve closing pressure increases faster than the operative system pressure. The system pressure is in a sense “overtaken” by the valve closing pressure. Despite the rising system pressure, the valve thus closes. In the terminal position of the switch element, the valve opening pressure and the valve closing pressure remain constant, at an elevated level.

The system pressure is raised further, until it is once again above the increased valve opening pressure. Now the valve element again opens counter to the increased valve prestressing force, for a main injection. The main injection is terminated by lowering the system pressure to a pressure below the (increased) valve closing pressure. The switch element is moved back into its outset position again, so that the valve opening pressure and the valve closing pressure also drop back to a normal level.

The increasing of the valve opening pressure is limited in the known method, because otherwise the interval between the preinjection and the main injection would be too long. However, in some applications, a very high injection pressure is desired. This is especially true whenever the main injection is also to be followed by a postinjection. An overly low pressure in the postinjection can cause an undesirably large amount of soot to be produced.

It is therefore the object of the present invention to refine a method of the type defined at the outset in such a way that with it, a postinjection at very high injection pressure is possible.

This object is attained, in a method of the type defined at the outset, in that in step b), a valve closing pressure that is increased because of the increased valve prestressing force is always below the system pressure, so that the valve element remains open; and that between steps b) and c), the following steps in succession are provided;

b1) lowering the system pressure to a value below the valve closing pressure, so that the valve element closes;

b2) increasing the system pressure so that the valve element opens for a postinjection at a valve opening pressure that is increased because of the increased valve prestressing force.

### ADVANTAGES OF THE INVENTION

In the method of the invention, the valve prestressing force is accordingly increased only fast enough that the valve closing pressure always remains below the system pressure. In contrast to the known method, this precludes the system pressure from being “overtaken” by the valve closing pressure so that the valve element closes despite the increasing system pressure. Thus a large portion of the duration of the main injection is available for increasing the valve prestressing force and thus also for increasing the valve opening pressure.

The valve prestressing force can therefore be increased to a very much greater extent than is possible with the known methods. The closure of the valve element between the main injection and the postinjection is actively brought about by providing that the system pressure is lowered. In other words, a “hydraulic” closure as in the known method is not provided here.

With the method of the invention, a postinjection at a very high injection pressure can thus be achieved. Especially with Diesel engines, this means combustion behavior that is especially well optimized in terms of fuel consumption and emissions.

Advantageous refinements of the invention are defined by dependent claims.

For instance, it is proposed that in step c), the system pressure is lowered to a value below an increased valve closing pressure, so that the valve element closes, and the valve prestressing force on the valve element is reduced, and the valve opening pressure, which is lower because of the reduced valve prestressing force, is always above the system pressure, so that the valve element remains closed. In this refinement, the valve element is thus already closed at a relatively high system pressure. This has the advantage that during the entire postinjection, a relatively high injection pressure prevails.

The refinement of the method of the invention in which the valve element opens counter to the valve prestressing force of a prestressing element, which is braced by a movable switch element, and that in step b), the switch element, during the raising of the system pressure, is moved counter to the valve prestressing force, so that the valve prestressing force increases, is especially preferred. Thus in this refinement of the method of the invention, a mechanical motion, which can be generated in a simple way, is used to vary the valve prestressing force and consequently to vary the valve opening pressure and the valve closing pressure.

This is also the thought behind the refinement in which in step c), the switch element is moved in the direction of the valve prestressing force back into its outset position.

It is also proposed that in step b), the switch element is moved hydraulically. In that case, electrical triggering of the switch element can for instance be dispensed with, which enhances the safety in the performance of the method of the invention.

It is especially preferred if in step b), the switch element is moved out of its outset position by a successive imposition of the system pressure on at least two pressure faces, counter to the imposition by the prestressing element, the first pressure face always being subjected to the system pressure and the second pressure face not being subjected to the system pressure until the switch element has moved somewhat out of its outset position.

In this way, it is assured that the switch element moves relatively quickly out of the outset position. Furthermore, hysteresis between the switching pressure at which the switch element moves out of the outset position and the switching pressure at which the switch element returns to its outset position is created. This prevents an unwanted drop in the valve opening pressure or the valve closing pressure during the drop in the system pressure during the main injection.

The method of the invention is especially preferred whenever a preinjection can be performed in addition to the main injection and postinjection. As a result, the fuel consumption and emissions performance of the engine operated by the method of the invention is still further optimized. To that end, it is proposed that before step a), the system pressure is raised to a value above the normal valve opening pressure, so that the valve element opens for a preinjection at normal system pressure, counter to the imposition by the prestressing element, and the system pressure is then lowered to a value below the normal valve closing pressure, so that the valve element closes. The preinjection performed in this way accordingly takes place at a relatively low control valve and with a switch element that is in the outset position.

Another possibility for increasing the valve opening pressure is to subject the valve element to pressure counter to the opening direction. This can be done in addition to or is an alternative to the subjection of the valve element to pressure by the prestressing element. To that end, it is also proposed that the valve element is subjected to pressure counter to the open direction, and as a result the valve opening pressure is increased. The system pressure prevails anyway in the region of the valve element and can therefore be employed, without complicated provisions, for increasing the valve opening pressure.

The present invention also relates to a unit fuel injector for supplying fuel to a combustion chamber of an internal combustion engine, having an injection nozzle, for injecting the fuel into the combustion chamber, having at least one valve element which has at least one first pressure face the force resultant of which points in approximately the opening direction of the valve element, having a prestressing element that urges the valve element in the direction of the closing position, having a switch element on which the prestressing element is braced and which is movable longitudinally of the pressure imposition direction by the prestressing element, having a pump device which builds up a system pressure that acts on the first pressure face of the valve element, and having a control device which controls the buildup and reduction of the system pressure.

A unit fuel injector of this kind is known on the market. As already noted at the outset, it is used above all in motor vehicle Diesel engines. With such a unit fuel injector, in order to achieve the best-optimized operation of the engine in terms of fuel consumption and emissions, it is proposed according to the invention that the characteristic curve of the valve prestressing device and the sizes of the pressure faces are adapted to one another such that with it the method of the type defined above can be performed.

In a refinement of the unit fuel injector of the invention, it is proposed that the switch element has a first pressure face and a second pressure face; the first pressure face of the switch element is smaller than the first pressure face of the valve element; the first pressure face and the second pressure face of the switch element together are larger than the total pressure face of the valve element; the first pressure face of the switch element always communicates with the pump device, so that they are always subjected to the system pressure; and the second pressure face of the switch element does not communicate with the pump device until the switch element has moved somewhat out of its outset position.

In this unit fuel injector, there is a hysteresis between the system pressure at which the switch element moves out of the outset position and the system pressure at which the switch element returns to the outset position. This increases the operating safety of the unit fuel injector.

It is also proposed that a sealing edge is present, which in the outset position of the switch element separates the two pressure faces from one another. In this embodiment of the unit fuel injector of the invention, the successive subjection of the switch element to the system pressure is achieved in an especially simple way.

A valve prestressing device which includes a compression spring is also especially simple to realize.

In another preferred refinement of the unit fuel injector of the invention, between the valve element and the switch element is a pressure chamber, defined by a second pressure face of the valve element whose force resultant is oriented approximately oppositely to the force resultant of the first pressure face of the valve element, and a flow conduit which leads from the pressure chamber to the second pressure face of the switch element is provided in the switch element.

In this unit fuel injector, as an alternative to or in addition to the prestressing by means of a compression spring, the valve element can for instance be acted upon by a hydraulic pressure, as a result of which once again the valve opening pressure and the valve closing pressure can be increased. This subjection to pressure is accomplished by having the pressure chamber between the switch element and the valve element communicate fluidically with the pressure chamber that is defined by the second pressure face of the switch element. The subjection of the pressure chamber to hydraulic pressure between the switch element and the valve element thus does not occur until the switch element has moved out of its outset position somewhat.

In this respect it is especially preferred if the flow conduit includes a flow throttle. As a result, the pressure in the pressure chamber between the valve element and the switch element builds up only gradually. This in turn assures that during the rise in the system pressure, the valve closing pressure will not “catch up with” the system pressure.

A simple realization for a flow conduit of this kind, optionally with a flow throttle, comprises a through bore through the switch element. It is also possible to provide a gap between the switch element and a housing that surrounds the switch element. This can be done for instance in the form of a ground face on one region of the outer jacket of the switch element. All of these embodiments of a flow conduit are easy to realize.

In another refinement of the unit fuel injector of the invention, it is proposed that the control device includes a switching valve, which can cause the pump device to communicate with a low-pressure region. As a result, it is attained that whenever the pump device pumps fuel to the valve element, yet an increase in the system pressure is unwanted, the volumetric flow in the direction of the low-pressure region can be drained off, and thus no system pressure builds up.

Especially fast switching of a switching valve of this kind is attained whenever the switching valve has at least one piezoelectric element as an actuator.

With the unit fuel injector of the invention, very high valve opening pressures can be achieved. Preferably, the increased valve opening pressure is more than twice as high as the normal valve opening pressure; more preferably, it is at 400 to 800 bar, and still more preferably at 700 to 800 bar.

### DRAWING

Below, exemplary embodiments of the invention are described in detail in conjunction with the accompanying drawing. Shown in the drawing are:

FIG. 1: a schematic illustration of a first exemplary embodiment of a unit fuel injector;

FIG. 2: a graph showing the switching state of a control valve of the unit fuel injector of FIG. 1 over time;

FIG. 3: a graph showing the course of the system pressure of the unit fuel injector of FIG. 1 over time;

FIG. 4: a graph in which the switching state of a switch element of the unit fuel injector of FIG. 1 is plotted over time;

FIG. 5: a graph in which the switching state of a valve element of the unit fuel injector of FIG. 1 is plotted over time;

FIG. 6: a detail of a second exemplary embodiment of a unit fuel injector;

FIG. 7: an elevation view similar to FIG. 6 of a third exemplary embodiment of a unit fuel injector; and

FIG. 8: a view similar to FIG. 6 of a variant exemplary embodiment of a unit fuel injector.

### DESCRIPTION OF THE EXEMPLARY EMBODIMENTS

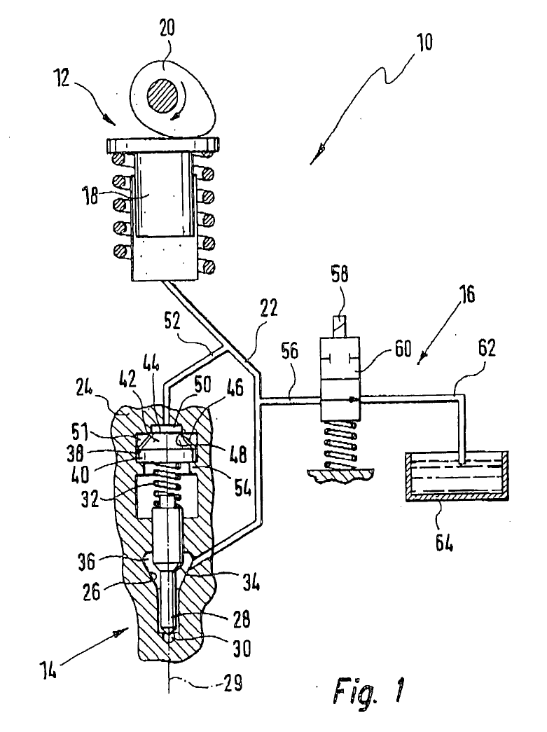

A first exemplary embodiment of a unit fuel injector is identified overall in FIG. 1 by reference numeral 10. It includes a pump device 12, a nozzle device 14, and a control device 16.

The pump device 12 is a single-cylinder piston pump 18, which is driven by a cam 20. The cam 20 is in turn coupled to the crankshaft of an internal combustion engine (not shown). Upon each supply stroke, the pump device 12 pumps fuel, via a line, not shown, from a tank 64 to the nozzle device 14 via a fuel line 22.

The nozzle device 14 includes a housing 24, in which a stepped bore 26 is embodied. A valve element 28 of circular-cylindrical cross section is guided in the stepped bore 26. The valve element 28 is movable along its longitudinal axis 29. There is an injection opening 30 on the lower end of the housing 24. The valve element 28 is pressed by a compression spring 32 against a valve seat (not visible) in the region of the injection opening 30. The valve element 28 has an oblique first pressure face 34, extending all the way around it, which is surrounded by an annular pressure chamber 36. The pressure chamber 36 is in turn in communication with the fuel line 22.

The end of the compression spring 32 remote from the valve element 28 is braced on a circular-cylindrical switch element 38. The switch element has one portion 40, oriented toward the compression spring 32, of constant diameter and another portion 42, remote from the compression spring 32, that tapers conically in the form of a truncated cone. The truncated tip of the conical portion 42 forms a first pressure face 44 of the switch element 38, while conversely the oblique jacket face of the conical portion 42 of the switch element 38 forms a second pressure face 46.

The switch element 38 is pressed into the outset position shown in FIG. 1 by the compression spring 32. In this outset position, an upper portion of the conical pressure face 46 rests on an annular sealing edge 48 of the stepped bore 26. The region above the first pressure face 44 of the switch element 38 forms a first pressure chamber 50, which via a branch line 52 constantly communicates fluidically with the fuel line 22. Between the housing 24 and the pressure face 46, there is a second, annular pressure chamber 51.

In the stepped bore 26, the switch element 38 can move along the longitudinal axis 29 between the outset position, shown in FIG. 1, and a switching position defined by a radially inward-pointing annular rib 54. In this switching position, the sealing edge 48 no longer rests on the oblique pressure face 46 of the switch element 38, so that the two pressure chambers 50 and 51 communicate with one another.

A branch line 56 branches off from the fuel line 22 and leads to the control device 16. The control device 16 includes a switching valve 60, which is actuatable by a piezoelectric actuator 58 and which communicates on its outlet side, via a low-pressure line, with the fuel tank 64. The piezoelectric actuator 58 of the control device 16 is triggered by a control and regulating device, not shown in the drawing. In an exemplary embodiment not shown, a magnetic actuator is used instead of a piezoelectric actuator.

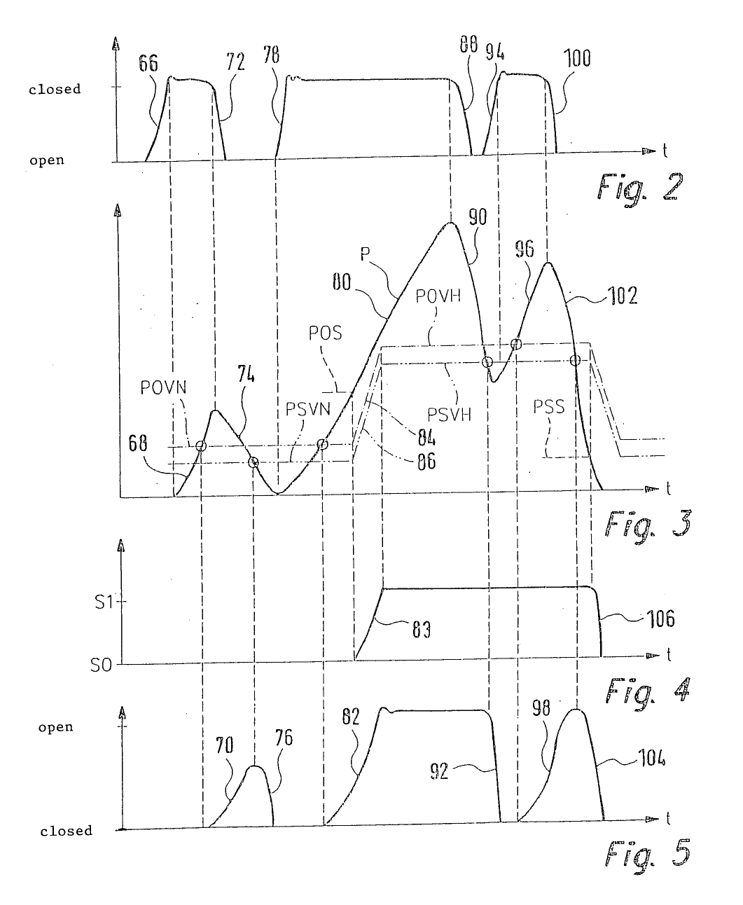

The unit fuel injector 10 shown in FIG. 1 is used to inject fuel into the combustion chamber of an internal combustion engine. Each combustion chamber (and thus each cylinder) of the engine is provided with its own unit fuel injector 10. The fuel can reach the combustion chamber of the engine through a “triple injection”. The method by which this kind of triple injection takes place will now be explained in conjunction with FIGS. 2-5:

The cam 20 of the pump device 12 is synchronized with the crankshaft of the engine in such a way that the single-cylinder piston pump always performs one supply stroke during one injection stroke of the cylinder associated with it. As FIG. 2 shows, the switching valve 60, at the onset of an injection stroke, is initially closed (ascending edge 66 in FIG. 2). As can be seen from FIG. 3, this leads to an increase in the system pressure in the fuel line 22 and consequently also in the pressure chamber 36 (ascending edge 68 in FIG. 3). By the spring force of the compression spring 32, the valve element 28 is pressed with a certain force against the corresponding valve seat in the region of the injection opening 30. A normal valve opening pressure is predetermined as a result.

The increasing pressure in the pressure chamber 36 now acts on the pressure face 34 of the valve element 28. If the force that results from this exceeds the closing force exerted by the compression spring 32, then the normal valve opening pressure of the valve element 28 is exceeded; the valve element 28 lifts from the valve seat in the region of the injection opening 30 and opens. The normal valve opening pressure is represented by a dot-dashed curve in FIG. 3, marked POVN. The opening of the valve element 28 can be seen from the ascending edge 70 in FIG. 5. By means of this opening of the valve element 28, a preinjection is performed.

The preinjection is terminated by providing that the switching valve 60 opens again (descending edge 72 in FIG. 2). As a result, the system pressure in the fuel line 22 drops, since this line is after all now open to the fuel tank 64. This is represented by the descending edge 74 in FIG. 3. Correspondingly, the valve element 28 closes (descending edge 76 in FIG. 5), as soon as the system pressure P in FIG. 3 has dropped below a normal valve closing pressure PSVN. The valve closing pressure PSVN is represented by a double dot-dash line in FIG. 3.

To perform a main injection of fuel, the switching valve 60 is closed again (ascending edge 78 in FIG. 2). Accordingly, the system pressure P rises (edge 80 in FIG. 3). As soon as the valve opening pressure POVN is exceeded, the valve element 28 opens (ascending edge 82 in FIG. 5).

In the process, the system pressure P exceeds an opening switching pressure POS of the switch element 38. This pressure POS is equivalent to the pressure at which the switch element 38 begins to separate itself from the sealing edge 48. This in turn is the case whenever the force originating at the pressure face 44 exceeds the valve prestressing force of the compression spring 32. As soon as the switch element 38 has separated somewhat from the sealing edge 48, the second pressure face 46 is also subjected to the system pressure P. The result is that the switch element 38 moves downward, counter to the action by the compression spring 32, until it rests on the annular rib 54 (edge 83 in FIG. 4).

As a result, the compression spring 32 is compressed, which in turn increases the spring force exerted on the valve element 28 by the compression spring 32. This in turn causes an increase in the valve opening pressure to a value POVH and in the valve closing pressure to a value PSVH in FIG. 3 (reference numerals 84 and 86). The switching position of the switch element 38 can be seen from FIG. 4.

The outset position is marked S0, while conversely the switching position at which the switch element 38 rests on the annular rib 54 is marked S1. The characteristic curve of the spring 32 and the sizes of the pressure faces 34 and 44 are adapted to one another in such a way that during this increasing of the system pressure P, the valve closing pressure PSV is always below the system pressure P.

The main injection is terminated, analogously to the end of the preinjection, in that the switching valve 60 is opened again. The corresponding descending edges in FIGS. 2, 3 and 5 are identified by reference numerals 88, 90 and 92. The closure of the valve element 28 is accomplished by providing that the system pressure P in FIG. 3 drops below the increased valve closing pressure PSVH. The drop in the system pressure P is limited, however, such that a switching pressure PSS, at which the switch element 38 returns to its outset position S0 again, is not undershot.

A postinjection is initiated again by a closure of the switching valve 60. The corresponding edges in FIGS. 2, 3 and 5 are marked with reference numerals 94, 96 and 98. The system pressure P in this process again exceeds the increased valve opening pressure POVH, so that the valve element 28 opens again. Since the increased valve opening pressure POVH is considerably above the normal valve opening pressure POVN, the postinjection takes place at a correspondingly high injection pressure. Typical values for a normal valve opening pressure are approximately 300 bar, while the injection pressure in the postinjection, because of the increased valve opening pressure POVH, is at approximately 500 to 600 bar.

The entire injection sequence is terminated by providing that the switching valve 60 is opened again (descending edge 100 in FIG. 2). The system pressure P now drops again fully, and in so doing first drops below the increased valve closing pressure PSVH (descending edge 102 in FIG. 3) and then below the closing switching pressure PSS for the switch element 38 as well. Thus the valve element 28 first closes (descending edge 104 in FIG. 5), and then (if P<PSS) the switch element 38 also moves again back into its outset position (descending edge 106 in FIG. 4).

By means of this kind of postinjection at a relatively high injection pressure, fuel combustion in the combustion chamber of the engine that is optimal in terms of fuel consumption and emissions is possible. Analogously to the increasing of the pressures POV and PSV, it is assured here as well that while the system pressure P is dropping, the pressures POV and PSV are always above the system pressure P.

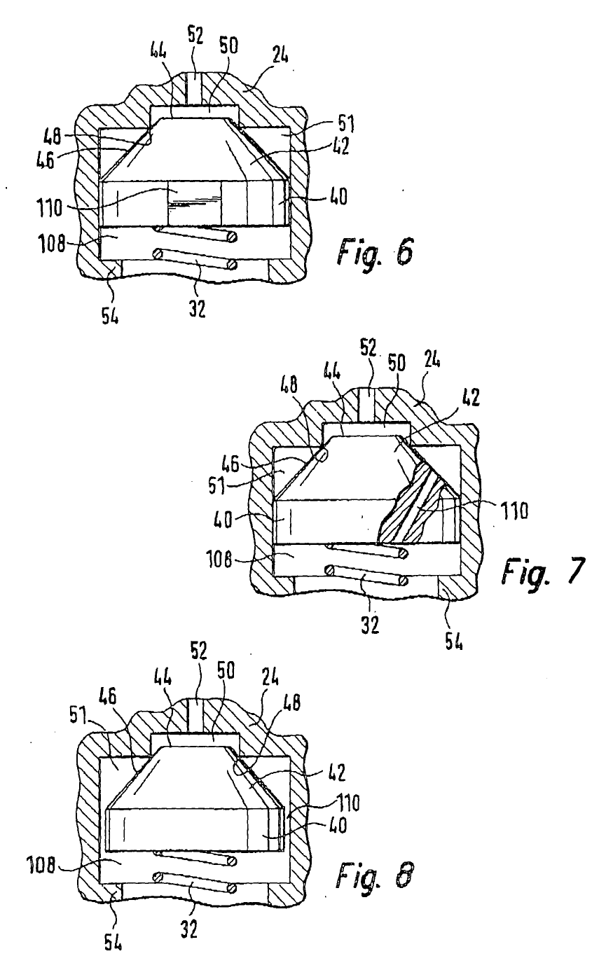

In FIGS. 6, 7 and 8, further exemplary embodiments for a unit fuel injector 10 are shown. Elements that have equivalent functions to corresponding parts in FIG. 1 are identified by the same reference numerals and will not be described again in detail.

The differences between the exemplary embodiments shown in FIGS. 6-8 from the exemplary embodiment of a unit fuel injector 10 shown in FIG. 1 pertain to the embodiment of the switch element 38. In the exemplary embodiment shown in FIG. 1, the region of the stepped bore 26 formed between the valve element 28 and the switch element 38 was not put under pressure. Thus in that case, only the valve prestressing force, which is brought to bear by the compression spring 32, acts on the valve element 28.

In the exemplary embodiments shown in FIGS. 6-8, conversely, the region of the stepped bore 26 embodied between the valve element 28 and the switch element 38 is embodied as a pressure chamber 108, which via a flow conduit 110 communicates with the pressure chamber 51 above the second pressure face 46 of the switch element 38. In FIG. 6, the flow conduit is embodied as a plane ground face 110 on the otherwise circular-cylindrically curved outer face of the switch element 38. In FIG. 7, instead, a through bore 110 embodied as a flow throttle is made to pass through the switch element 38. In FIG. 8, in turn, there is simply an annular gap 110 between the switch element 38 and the wall of the housing 24. The reason for these provisions is as follows:

If the system pressure P exceeds the opening switching pressure POS of the switch element 38, then the switch element 38 lifts from the sealing edge 48, so that both the second pressure chamber 51 and the first pressure chamber 50 communicate with the fuel line 22, and thus both pressure faces 44 and 46 are subjected to the system pressure P. Via the flow conduit 110, the fuel now also flows into the pressure chamber 108 formed between the switch element 38 and the valve element 28, so that in this pressure chamber as well, a corresponding pressure builds up, up to the level of the system pressure P. This pressure also acts on the pressure face (not visible in FIGS. 6-8) of the valve element 28 that is oriented toward the compression spring 32, so that the valve element is acted upon with a corresponding compressive force, in addition to the valve prestressing force of the compression spring 32.

As a result, the valve opening pressure POV is increased once again, so that in these exemplary embodiments an especially high injection pressure, of up to 800 bar, can be realized. If the pressure chamber 108 is likewise acted upon by the system pressure, there could be the risk that the hydraulic force resultant acting on the switch element 38 becomes less than the force exerted on the switch element 38 by the compression spring 32. In that case, the switch element 38 would move back into its outset position again.

These problems arise, however, only at low engine rpm. At medium and high rpm levels, the injection pressure or system pressure increases continuously in the unit fuel injector 10 in question. However, because of the flow throttle 110, the pressure in the pressure chamber 108 rises only with a time lag. It is thus assured that during the rise in the system pressure P, the also-rising valve closing pressure PSV does not “overtake” the system pressure P, and the closing pressure PSS of the switch element 38 is also always below the system pressure P. Thus the valve element 28 on the one hand and the switch element 38 on the other both remain in the desired open or disengaged position.

Both at low engine rpm or engine idling and when starting the engine, the system pressure does not increase further if the duration of injection increases. Precisely enough fuel, as is replenished via the piston (not identified by reference numeral) of the single-cylinder piston pump 18, is injected. The pressure here is in the range of the static opening pressure of the valve element 28. At this pressure, the switch element 38 remains in its outset position. Hence there is no fluidic communication between the pressure chamber 108 and the pressure chamber 50 or fuel line 22. This means that the pressure chamber 108 is not put under pressure.

In the transitional range, in which the switch element 38 has been moved out of its outset position yet the system pressure establishes itself at a constant level above the switching pressure POS, it could happen, despite the throttling action in the flow conduit 110, that the same pressure might prevail both in the pressure chamber 108 and in the pressure chambers 50 and 51. In such a case, to prevent the switch element 38 from returning unintentionally to its outset position, the area ratios, for instance between the face area of the switch element 38 toward the pressure chamber 108 and the area of the two pressure faces 50 and 51, can be selected accordingly. It is also possible for the cross section of the flow throttle 110 to be selected as suitably small.

However, if in certain situations, with such a small cross section of the flow conduit 110, the pressure buildup in the pressure chamber 108 might be too slow, this can be remedied by providing a second flow conduit (not shown). This second flow conduit connects the pressure chamber 108 with the low-pressure region, such as the fuel tank.

By means of this flow conduit, which has a corresponding flow-throttling effect, it is achieved that the maximum pressure in the pressure chamber is always at a defined ratio to the system pressure. At relatively low pressures, a relatively low pressure would thus also prevail in the pressure chamber 108, while conversely the pressure in the pressure chamber 108 at a high system pressure is correspondingly higher. This provision also prevents an excessively sharp rise in the pressure in the pressure chamber 108 between the valve element and the switch element from causing unwanted motions of the switch element or of the valve element.

1. A method for operating a unit fuel injector (10), with which fuel is injected into a combustion chamber of an internal combustion engine, in such a way that a valve element (28) is opened counter to a valve prestressing force by an elevation of a system pressure (P), the method including the following steps in succession:
a) raising (80) the system pressure (P) to a value above a normal valve opening pressure (POVN), so that the valve element (28) opens (82) counter to the valve prestressing force for a main injection;
b) increasing the valve prestressing force during the raising (80) of the system pressure (P);
c) lowering (102) the system pressure (P) and decreasing the valve prestressing force, so that the valve element (28) closes (104),
characterized in that
in step b), a valve closing pressure (PSVH) that is increased because of the increased valve prestressing force is always below the system pressure (P), so that the valve element (28) remains open; and that between steps b) and c), the following steps in succession are provided;
b1) lowering (90) the system pressure (P) to a value below the increased valve closing pressure (PSVH), so that the valve element (28) closes (92);
b2) increasing (96) the system pressure (P) so that the valve element (28) opens (98) for a postinjection at a valve opening pressure (POVH) that is increased because of the increased valve prestressing force.

2. The method of claim 1, characterized in that in step c), the system pressure (P) is lowered (102) to a value below an increased valve closing pressure (PSVH), so that the valve element (28) closes, and the valve prestressing force on the valve element (28) is reduced, and the valve opening pressure (POV), which is lower because of the reduced valve prestressing force, is always above the system pressure (P), so that the valve element (28) remains closed.

3. The method of one of the foregoing claims, characterized in that the valve element (28) opens counter to the valve prestressing force of a prestressing element (32), which is braced by a movable switch element (38); and that in step b), the switch element (38), during the raising (80) of the system pressure (P), is moved (83) counter to the valve prestressing force, so that the valve prestressing force increases.

4. The method of claim 3, characterized in that in step c), the switch element (38) is moved (106) in the direction of the valve prestressing force back into its outset position (SO).

5. The method of one of claims 3 or 4, characterized in that in step b), the switch element is moved hydraulically (106).

6. The method of claim 5, characterized in that in step b), the switch element (38) is moved out of its outset position (S0) by a successive imposition of the system pressure (P) on at least two pressure faces (44, 46), counter to the imposition by the prestressing element (32), the first pressure face (44) always being subjected to the system pressure (P) and the second pressure face (46) not being subjected to the system pressure (P) until the switch element (38) has moved somewhat out of its outset position (SO).

7. The method of one of the foregoing claims, characterized in that before step a), the system pressure (P) is raised (68) to a value above the normal valve opening pressure (POVN), so that the valve element (28) opens (70) for a preinjection at normal system pressure (P), counter to the imposition by the prestressing element (32), and the system pressure (P) is then lowered (74) to a value below the normal valve closing pressure (PSVN), so that the valve element (28) closes (76).

8. The method of one of the foregoing claims, characterized in that the valve element (28) is subjected to pressure (P) counter to the opening direction, and as a result the valve opening pressure (POV) is increased.

9. The method of claim 8, characterized in that the valve element (28) is subjected to the system pressure (P) counter to the opening direction in chronologically staggered fashion.

10. A unit fuel injector (10) for supplying fuel to a combustion chamber of an internal combustion engine, having an injection nozzle (30), for injecting the fuel into the combustion chamber, having at least one valve element (28) which has at least one first pressure face (34) whose force resultant points in approximately the opening direction of the valve element (28), having a prestressing element (32) that urges the valve element (28) in the direction of the closing position, having a switch element (38) on which the prestressing element (32) is braced and which is movable longitudinally of the pressure imposition direction by the prestressing element (32), having a pump device (12) which builds up a system pressure (P) that acts on the first pressure face (34) of the valve element (28), and having a control device (16) which controls the buildup and reduction of the system pressure (P), characterized in that the characteristic curve of the valve prestressing device and the sizes of the pressure faces (34) are adapted to one another such that with it the method of one of claims 1-6 can be performed.

11. The unit fuel injector (10) of claim 10, characterized in that the switch element (38) has a first pressure face (44) and a second pressure face (46); the first pressure face (44) of the switch element (38) is smaller than the first pressure face (34) of the valve element (28); the first pressure face (44) and the second pressure face (46) of the switch element (38) together are larger than the total pressure face (34) of the valve element (28); the first pressure face (44) of the switch element (38) always communicates with the pump device (12), so that they are always subjected to the system pressure (P); and the second pressure face (46) of the switch element (38) does not communicate with the pump device (12) until the switch element (38) has moved somewhat out of its outset position (SO).

12. The unit fuel injector (10) of claim 11, characterized in that a sealing edge (48) is present, which in the outset position (SO) of the switch element (38) separates the two pressure faces (44, 46) from one another.

13. The unit fuel injector (10) of one of claims 10-12, characterized in that the valve prestressing device includes a compression spring (32).

14. The unit fuel injector (10) of one of claims 10-13, characterized in that between the valve element (28) and the switch element (38), there is a pressure chamber (108), defined by a second pressure face (112) of the valve element (28), whose force resultant is oriented approximately oppositely to the force resultant of the first pressure face (34) of the valve element (28); and that in the switch element (38), a flow conduit (110) is provided, which leads from the pressure chamber (108) to the second pressure face (46) of the switch element (38).

15. The unit fuel injector (10) of claim 14, characterized in that the flow conduit (110) includes a flow throttle.

16. The unit fuel injector (10) of one of claims 14 or 15, characterized in that there is a through bore (110) through the switch element (38).

17. The unit fuel injector (10) of one of claims 14-16, characterized in that there is a gap (110) between the switch element (38) and a housing (24) that surrounds the switch element (38).

18. The unit fuel injector (10) of one of claims 10-17, characterized in that the control device (16) includes a switching valve (60), which can cause the pump device (12) to communicate with a low-pressure region (62, 64).

19. The unit fuel injector (10) of claim 18, characterized in that the switching valve (60) has at least one piezoelectric element (58) as an actuator.

20. The unit fuel injector (10) of one of claims 10-19, characterized in that the increased valve opening pressure (POVH) is more than twice as high as the normal valve opening pressure (POVN), preferably being approximately 400 to 800 bar, and further preferably being 700 to 800 bar.
